(19) United States
(12) Patent Application Publication
(10) Pub. No.: US 2023/0109053 A1
(43) Pub. Date: Apr. 6, 2023

(54) CONFIGURING APPLICATION INSTANCES ON SCALING

(71) Applicant: INTERNATIONAL BUSINESS MACHINES CORPORATION, ARMONK, NY (US)

(72) Inventors: Martin A. Ross, Gosport (GB); Jack William Donato Evans, Rochester (GB); Luke James Powlett, Romsey (GB); Jack Richard William Stevenson, Winchester (GB)

(21) Appl. No.: 17/448,781

(22) Filed: Sep. 24, 2021

(51) Int. Cl. G06F 9/445; G06F 9/54; G06F 11/34

(52) U.S. Cl. CPC G06F 9/44505; G06F 9/54; G06F 11/3409

(57) ABSTRACT

A method, computer system, and a computer program product for configuring application instances on scaling is provided. The present invention may include receiving a client request, wherein the client request includes one or more commands. The present invention may include determining whether the client request is to be acted on by all application instances based on a type of client request, wherein the type of client request is determined based on at least routing metadata in an application interface specification. The present invention may include determining the client request is be acted on by all application instances.

### BACKGROUND

The present invention relates to scalable applications, and more specifically, to configuring application instances on scaling.

Cloud computing includes platform as a service (PaaS) providing a capability to the consumer to deploy onto a cloud infrastructure consumer-created or acquired applications. Cloud providers deliver a computing platform, typically including an operating system, programming language execution environment, database, and web server. Application developers develop and run their software on the cloud platform and the underlying computer and storage resources may scale automatically to match application demand.

Some cloud platforms allow applications to be scaled independently of the rest of the system by providing multiple instances (i.e. replicas) of an application to be deployed. A workload balancer typically sits in front of the multiple application instances to balance work between the application instances. The workload balancer may round-robin traffic between the application instances and this works well for a runtime workload. Some cloud platforms provide an ability to send client requests to a specific instance of an application or to round-robin. This works well for transactional workload, but for commands that change application behavior (i.e. runtime state) this is not ideal as the command would just go to one of the instances of the application.

For the case of a command that changes application behavior, a routing component is known to provide routing in accordance with an interface specification registered to an application. Routing of a request is then based on metadata associated with the interface specification. When a request is made to the application, it is first processed by the routing component, which looks at the registered interface specification and routes the request according to the associated metadata. The metadata may indicate that instead of a request being sent to a single instance of the application, it should be sent to all instances.

If a command has been actioned by all instances of an application, and a new instance of the application is subsequently launched (e.g. due to autoscaling), the new instance may not receive the command. This may lead to an undesirable inconsistency across the application instances.

### SUMMARY

Embodiments of the present invention disclose a method, computing system, and a computer program product for configuring application instances on scaling. The present invention may include receiving a client request, wherein the client request includes one or more commands. The present invention may include determining whether the client request is to be acted on by all application instances based on a type of client request, wherein the type of client request is determined based on at least routing metadata in an application interface specification. The present invention may include determining the client request is be acted on by all application instances.

According to an aspect of the present invention there is provided a computer-implemented method for a computer-implemented method for configuring application instances on scaling, the method being carried out at a routing component for requests to application instances and comprising: caching commands from client requests to be acted on by all application instances, wherein the commands are cached for sending to future application instances; canceling cached commands if a canceling command is received in a subsequent client request for all application instances; and identifying a new application instance and sending a current set of cached commands to configure the new application instance.

According to a further aspect of the present invention there is provided a system for a system for coordinating requests actioned at a scalable application, comprising: a processor and a memory configured to provide computer program instructions to the processor to execute the function of the components: a command caching component for caching commands from client requests to be acted on by all application instances, wherein the commands are cached for sending to future application instances; a command canceling component for canceling cached commands if a canceling command is received in a subsequent client request for all application instances; and a new application instance component for identifying a new application instance and including a cached command sending component for sending a current set of cached commands to configure the new application instance.

According to a further aspect of the present invention there is provided a computer program product for a computer program product for configuring application instances on scaling, the computer program product comprising a computer readable storage medium having program instructions embodied therewith, the program instructions executable by a processor to cause the processor to: cache commands from client requests to be acted on by all application instances, wherein the commands are cached for sending to future application instances; cancel cached commands if a canceling command is received in a subsequent client request for all application instances; and identify a new application instance and sending a current set of cached commands to configure the new application instance.

The computer readable storage medium may be a non-transitory computer readable storage medium and the computer readable program code may be executable by a processing circuit.

### BRIEF DESCRIPTION OF THE SEVERAL VIEWS OF THE DRAWINGS

The subject matter regarded as the invention is particularly pointed out and distinctly claimed in the concluding portion of the specification. The invention, both as to organization and method of operation, together with objects, features, and advantages thereof, may best be understood by reference to the following detailed description when read with the accompanying drawings.

Preferred embodiments of the present invention will now be described, by way of example only, with reference to the following drawings in which:

FIG. 1 is a schematic diagram of a system according to at least one embodiment;

FIG. 2 is a flow diagram illustrating a process for configuring application instances on scaling according to at least one embodiment;

FIG. 3 is a block diagram of a system according to at least one embodiment;

FIG. 4 illustrates a networked computer environment according to at least one embodiment;

FIG. 5 is block diagram of an illustrative cloud computing environment, in accordance with an embodiment of the present disclosure; and

FIG. 6 is a block diagram of functional layers of the illustrative cloud computing environment, in accordance with an embodiment of the present disclosure.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numbers may be repeated among the figures to indicate corresponding or analogous features.

### DETAILED DESCRIPTION

A method and system are provided for configuring application instances on scaling. Scalability in the context of cloud computing may be regarded as the ability to handle growing or diminishing resources to meet traffic demands in a capable way. In essence, scalability may provide a level of capacity that can grow or shrink as required. A scalable application may have multiple application instances in the form of replicas of the application which can each carry out the function of the application. The application instances may be provided across cloud resources including across different cloud service providers in a multi-cloud or hybrid cloud solution.

The term “application instance” may include instances of a whole application or a component of an application such as deployed and scaled in microservice architectures.

Requests may be sent to application instances and may be in the form of a command to take an action. Commands are defined as any form of request to take an action by an application instance. As one example, commands may be provided in the form of Hypertext Transfer Protocol (HTTP) requests. As another example, a proprietary protocol may be built on top of the Transmission Control Protocol (TCP) to provide commands. A request may be routed to only one of the application instances or multiple application instances. The number of application instances may vary and a scalable application may have a single application instance or multiple application instances at any point in time.

The described method and system provide a mechanism by which requests or actions that have been sprayed out to multiple application instances can be configured at a new application instance that is added after the requests or actions have been sent to the application instances. The method and system are provided at a router component provided between client commands and application instances that may be provided as part of, hosted by or associated with a cloud platform.

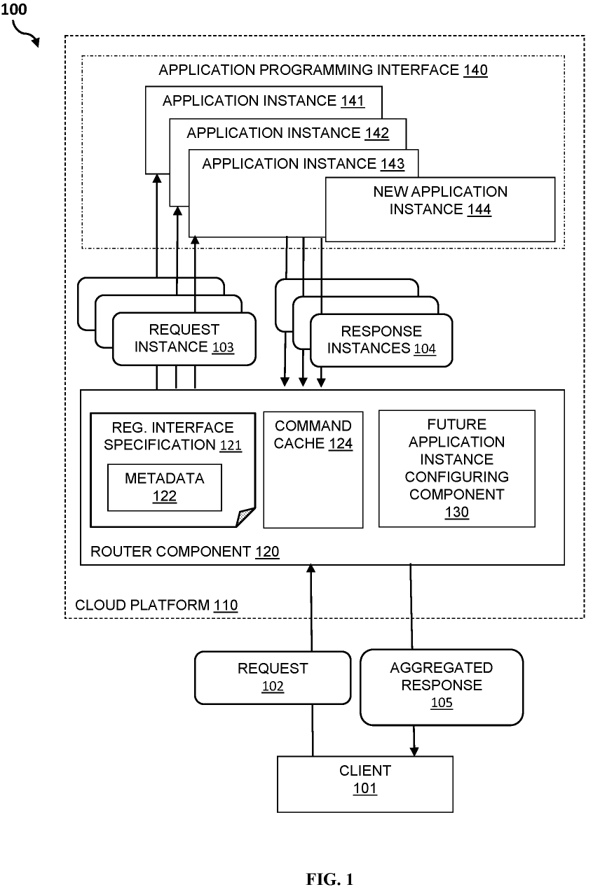

Referring to FIG. 1, a schematic diagram shows an example embodiment of a system 100 in which the described method may be implemented. A cloud platform 110 is shown which provides a platform to develop, run, or manage applications. The cloud platform 110 may be any form of cloud platform providing routing and scaling capabilities. This may include as examples, a multi-cloud platform, hybrid-cloud platform, etc., and may enable microservice architectures where an application or a component of an application may be deployed and scaled independently from the rest of the system.

An application programming interface (API) 140 defines a set of specifications including request messages, for example, Hypertext Transfer Protocol (HTTP) request messages, and definitions of response messages for an application deployed on the platform 110. For scalability, an API 140 may support multiple application instances 141-143, for example, that may be provided on different servers of the cloud platform 110.

The API 140 may consist of one or more publicly exposed endpoints to a defined request-response message system. A client 101 may issue command requests to the API 140 relating to the development, running, or managing of the application. For example, these may be HTTP requests, for example, such as Representational state transfer (REST) API requests or Simple Object Access Protocol (SOAP) requests.

The cloud platform 110 may include a router component 120 for routing client requests 102 from a client 101 to the API 140. The router component 120 may have access to an interface specification 121 for the API 140 registered at or accessible to the router component 120. The router component 120 may be provided in a similar implementation to a workload balancer for balancing a workload between application instances. The described router component 120 may include the described functionality of a future application instance configuring component 130 that may be implemented in a router component 120.

The router component 120 includes functionality for coordinating a request 102 that is sent to an API 140 where the request can be actioned on multiple application instances 141-143. The interface specification 121 has associated metadata 122 that may relate to a required routing to a number of application instances for a type of request and, optionally, a required number of completed response instances to be received from the one or more application instances.

Response instances 104 to the request instances 103 are received at the router component 120 and an aggregated response 105 may be sent back to the client 101 compiling the response instances 104 from the application instances 141-143.

The future application instance configuring component 130 provides functionality for configuring future application instances that are scaled up so that the future application instances receive command requests that have previously been sent to all application instances and that have not yet been canceled. This provides a mechanism by which commands to be actioned by all instances of an application are actioned by future instances of the application, such as a new application instance 144 shown in FIG. 1. A command cache 124 may be provided at or accessible by the routing component 120 in which commands are cached for future application instances. The registered interface specification 121 may include additional metadata 122 to indicate commands that cancel or reverse other commands for reducing the commands at the command cache 124.

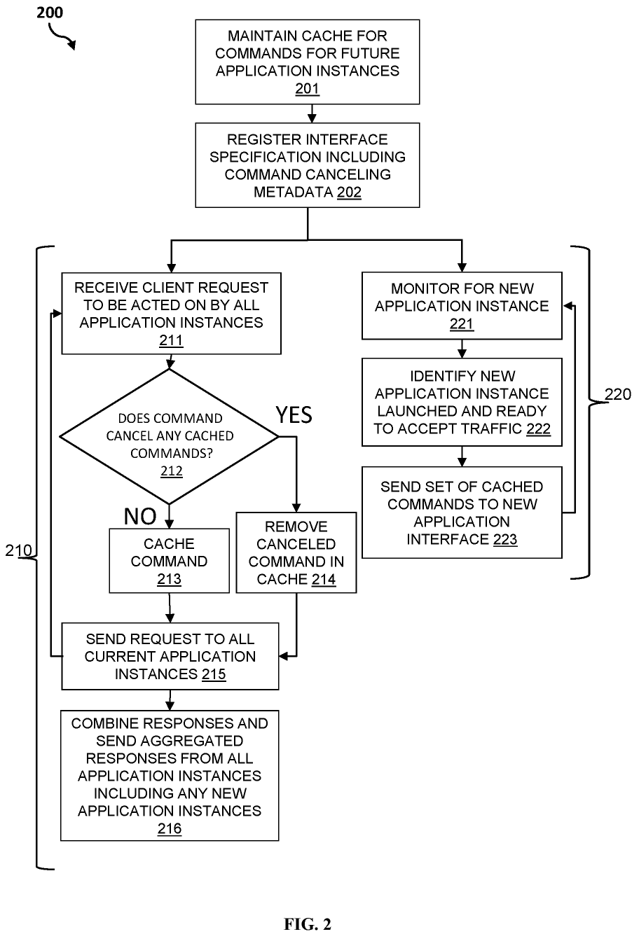

Referring to FIG. 2, a flow diagram 200 shows an example embodiment of the described method as carried out at a router component 120 provided in front of multiple application instances 141-143 located in a scalable cloud environment.

The method may maintain 201 a cache for commands for future application instances and may register 202 an interface specification which may include metadata relating to command cancelation by other commands to be applied when caching a command.

The method carried out at the router component 120 may include two branches. In an embodiment both branches 210 and 220 may take place in parallel. The first branch 210 may relate to the caching of commands and the updating of the cache to cancel commands. The second branch 220 may relate to determining if new application instances are added and sending cached commands to the new application interface. Both branches 210, 220 may loop to accommodate multiple client requests in the first branch 210 and multiple new application instances in the second branch 220.

In the first branch 210, the method may receive 211 a client request to be acted on by all the application instances. The client request may include one or more commands. Whether the client request may be acted on by all application instances may be determined by checking routing metadata in an application interface specification regarding request routing.

At 212, it may be determined if a command of the of the one or more commands of the received client request cancels any cached commands. This may be determined by checking cache metadata of the interface specification to find out which commands of the cached may be canceled by the one or more commands of the received client request and checking the cache to determine if any such canceled commands are in the cache. If it is determined 212 that the received request cancels a cached command, the cached canceled command is removed 214 from the cache. If it is determined 212 that the received request does not cancel a cached command, the command of the received request is cached 213.

The received request may then be sent 215 to all the current application instances. Responses received from the application instances may be combined 216 in accordance with response metadata of the interface specification. This may include responses from application instances that are added after the client request received at step 211.

In the second branch 220, the method may monitor 221 for new application instances and may identify 222 when a new application instance may be launched and ready to accept traffic. A set of cached commands may be sent 223 to the new application instance to bring it in line with the existing application instances which may have already received the commands.

The described method provides a mechanism by which commands to be actioned by all instances of an application, are also actioned by future instances of the application. This may address the problem of ensuring stateful changes made to a scalable application are applied to additional instances of said application when it may be scaled out. This may maintain consistency across all the application instances.

When requests come into the platform technology’s routing component and it may be determined that the request relates to a command to be actioned by all instances of an application, the routing component caches the command. The interface specification that may be registered with the routing component may include annotations to indicate commands that cancel other commands (e.g. stop trace would cancel start trace). The routing component may utilize this metadata to reduce the cache and may improve resource allocation. Accordingly, a new application instance may be launched, the routing component may send the new application instance an optimized set of commands.

The method and system utilize the routing component to route client requests to multiple instances of a running application based on metadata associated with a registered application interface specification. Optimized cache management ensures consistency on scale out of new application instances. The optimized cache management may include a rationalization of a set of commands which may optimize playback by cancelation of commands that cancel each other out. The rationalized set of commands may be played back to the new application instances to perform non-declarative state changes onto the new application instance on scale out.

The method and system may utilize an aggregation component for aggregating responses from each application instance and forming a single response to the client based on metadata associated with the API document of the application.

Applications that may be developed to run in a cloud environment and/or in a container orchestration environment may be designed to be stateless which may enable the application to scale. However, applications which may not have been developed in such environments may not have contemplated being stateless. Such applications may require adaptation to enable such applications to run in the cloud and/or with container orchestration. These applications may be likely candidates to have state. Such applications may not be re-written to consider runtime state management in a scalable cloud environment. The described method may benefit those applications as they may be migrated to the cloud.

The metadata may be annotations on the interface specification that are either created manually by a user and/or generated automatically using a machine-learning algorithm. A developer or engineer may create the interface specification including the metadata annotations. Metadata may be incorporated based on the type of expected request (PUT, GET, POST, etc.) and/or a basic set of metadata may be included if expected requests are not known. The metadata may provide an indication that the routing (i.e., the coordination/management) of a request and/or a response may be treated differently or in a particular manner. For instance, for the case of a command (i.e., a request) to enable tracing of an application, the annotations providing the metadata may indicate that the request should be sent to all application instances, rather than just one instance and that one completed response may be required, and a rule may be specified as to what constitutes a completed response.

The interface specification may be registered with the platform technology on deployment and may be accessible to a router component in front of the application instances. In this way, the requests may be distributed by the router component to each of the corresponding application instances outlined by the interface specification.

The interface specification can also be referred to as an interface document, API (application programming interface) document, or UI (user interface) specification, and may include a specification or description for the application adhering to a standardized framework. The interface specification for the application may include instructions relating to an interaction and/or integration with an application interface associated with the application. The interface specification may capture the details of the software user interface into a written document and cover all possible actions that an end user may perform via the application, as well as all visual, auditory and other interaction elements in the application. The interface specification may thus be the main source of implementation/integration information for how the application should work. Beyond implementation, the interface specification may consider usability, localization, and demo limits. In general, the goal of a requirement specification may be to describe what a product (i.e. an application) is capable of, whereas the interface specification may detail how these requirements are implemented in practice.

For example, the interface specification may be a Swagger® document in the form of a specification for machine-readable interface files for describing, producing, consuming, and visualizing RESTful (representational state transfer) web services (i.e., applications), and documenting RESTful API. Swagger® is a registered trademark of NutraClick, LLC. Representational state transfer is a software architectural style that defines a set of constraints to be used for creating web services. Web services that conform to the REST architectural style (i.e., RESTful web services) may provide interoperability between computer systems on the Internet. A RESTful API may be an application programming interface that may use HTTP requests which may enable two or more applications to communicate with each other.

The request may include a command to be performed on all the application instances. In one embodiment, these may be Hypertext Transfer Protocol (HTTP) requests.

Examples of such commands include, but are not limited to, the following:
enable or disable “some feature”
set trace to [debug | info | error]
set property “some property”

Canceling commands reverse the operation, for example:
“enable” is canceled by “disable”
“set info -> debug” is canceled by “set debug -> info”
“POST /v1/pets/cat” is be canceled by “DELETE /v1/pets/cat”

Proposed embodiments may employ a concept of invoking requests over RESTful interfaces to be routed to and completed by all instances of an application. The described command cache may provide such requests to further application instances.

### Trace Example

The following example may demonstrate how one possible implementation of the described method may work in practice.

An application may be deployed to a cloud computing platform, with three replicas, and has an associated interface specification in the form of an API document registered with the platform router component. The API document may include metadata on the /v1/startTrace and /v1/stopTrace APIs to indicate which requests should be fanned out to all instances and responses aggregated.

For example, the interface specification may include:

paths:
/v1/startTrace
get:
operationId: “startTrace”
summary: “Instruct the server to start tracing\n”
description: “Returns a successful response code if the server starts trace\n” routing:
request: “all-instances”
response: “aggregate”
cancels: “stopTrace”
responses:
200:
description: “OK”
503:
description: “Unavailable”
/v1/stopTrace:
get:
operationId: “stopTrace”
summary: “Instruct the server to stop tracing\n”
description: “Returns a successful response code if the server stops trace\n” routing:
request: “all-instances”
response: “aggregate”
cancels: “startTrace”
responses:
200:
description: “OK”
503:
description: “Unavailable”

An issue may be identified, and trace may be required, so a user may issue a command startTrace command via REST API to start a trace. The request may go to the router component where the API document is inspected and instead of just routing to one instance of the application, the trace request may be routed to all instances as the metadata describes.

The API document may also be inspected by the router component to determine whether the command cancels any cached commands. The API document for the path may not indicate to cancel any commands, so the startTrace command may be cached.

Each application instance may receive the request, processes successfully and may send a 200 response to acknowledge a trace has been started. The router component may wait for responses from all application instances in which the client request was routed to and then may aggregate one or more responses into a single response and send the aggregate response to the client application.

An aggregated response may, for example, be of the form:

HTTP Status Code: 200
[
{ “tracing started for server instance 1” },
{ “tracing started for server instance 2” },
{ “tracing started for server instance 3” }
]

At any stage, a new instance of the application may be launched (for example, due to autoscaling). When the new instance may be ready to accept traffic, the router component invokes it with the set of cached commands, in this case, the startTrace command.

A response may be used as an acknowledgement that the instance may be configured appropriately and may not sent back to the user in this method. An asynchronous model may be implemented to enable response back to the user asynchronously. Alternatively, audit logs from the service may be made available to the user to indicate the change of state was active on the new instance.

At a later stage, the user no longer requires tracing and issues a stopTrace command via REST API to stop the trace. The request goes to the router component where the API document may be inspected and instead of just routing to one instance of the application it may be routed to all instances as the metadata describes. This may include the new application instance as well as the existing application instances.

The API document may be inspected by the router component to determine whether the command cancels any cached commands. In this case, the stopTrace command may cancel the startTrace command that was cached. The router component may reduce the cache by removing the startTrace command.

Each application instance may receive the stopTrace request, processes this successfully and may send a 200 response to acknowledge that the trace has been stopped. The router component may wait for responses from all application instances that the request was routed to including the later added new application instance and then aggregates then all into a single response to the client application.

The aggregated response may, for example, be of the form:

HTTP Status Code: 200
[
{ “tracing stopped for server instance 1” },
{ “tracing stopped for server instance 2” },
{ “tracing stopped for server instance 3” },
{ “tracing stopped for server instance 4” }
]

Commands are now efficiently actioned by all instances of an application, including those application instances that may have been launched after the command of the client request by a user.

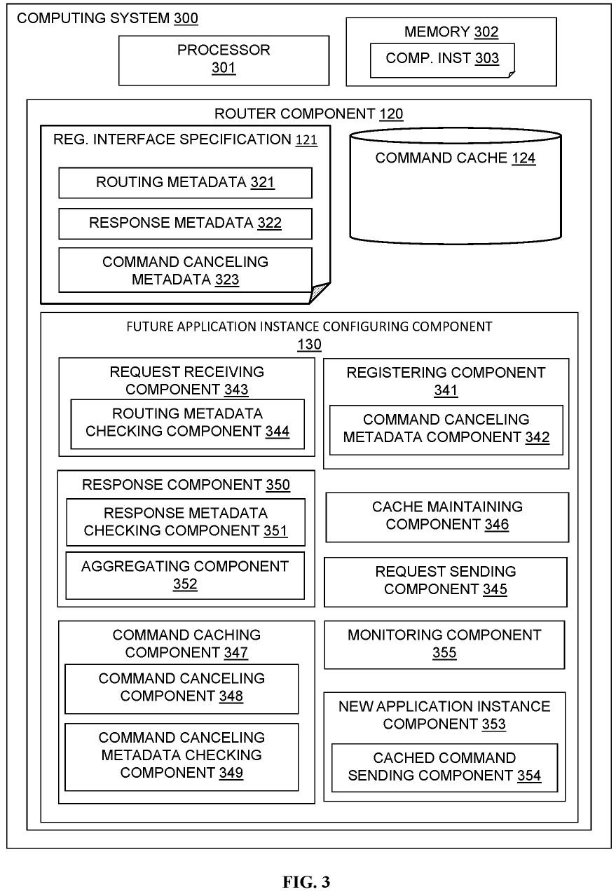

Referring to FIG. 3, a block diagram shows an example embodiment of a router component 120 provided in association with a scalable cloud environment. The router component 120 is provided on a computing system 300 that includes at least one processor 301, a hardware module, or a circuit for executing the functions of the described components which may be software units executing on the at least one processor. Multiple processors running parallel processing threads may be provided enabling parallel processing of some or all of the functions of the components. Memory 302 may be configured to provide computer instructions 303 to the at least one processor 301 to carry out the functionality of the components.

The router component 120 may include a command cache 124 for caching commands to be sent to future application instances in order to maintain consistency across applications instances.

The router component 120 includes a registered application interface specification 121 for an application. The registered application interface specification 121 includes routing metadata 321 relating to the routing behavior required for a request type, such as a number of application instances to which the request should be sent. The registered application interface specification 121 may include response metadata 322 regarding response behavior when actioning a request type. The registered application interface specification 121 may also include command canceling metadata 323 which may specify commands that cancel other commands in the described command cache 124.

The router component 120 may include a future application instance configuring component 130 this may include the following components providing the described functionality.

A cache maintaining component 346 may be provided for maintaining the command cache 124 of commands to be sent to future application instances and a registering component 341 which may be provided for registering an application interface specification for an application including a command canceling metadata component 342 for registering command canceling metadata for a request type indicating canceling commands to be applied to the cache of commands.

A request receiving component 343 may be provided for receiving a client request and this may include a routing metadata checking component 344 for determining that the request is to be sent to all application instances by checking routing metadata for the type of request in the application interface specification. A request sending component 345 may be provided for sending the request to all current application instances; and

A response component 350 may be provided for sending responses to a client request and may include a response metadata checking component 351 for checking response metadata for the type of request in the application interface specification. The response component 350 may also include an aggregating component 352 for aggregating responses from the application instances into a single response.

A command caching component 347 may be provided for caching commands from client requests to be acted on by all application instances. The command caching component 347 may include a command canceling component 348 for canceling cached commands if a canceling command is received in a subsequent client request for all application instances. The command caching component 347 may also include a command canceling metadata checking component 349 for determining whether a command may be a canceling command by checking the command canceling metadata for a type of request in the application interface specification.

A monitoring application 355 may be provided for monitoring for new application instances and determining that a new application interface may be launched and ready to receive requests. A new application instance component 353 may be provided for identifying a new application instance and including a cached command sending component 354 for sending a current set of cached commands to configure the new application instance.

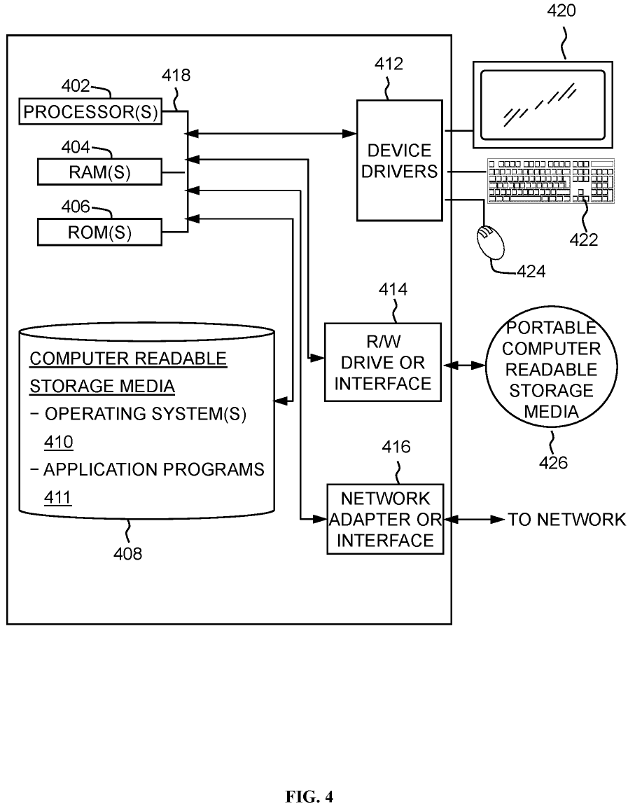

FIG. 4 depicts a block diagram of components of a computing system as used for the system of the router component 120 in the cloud platform 110, in accordance with an embodiment of the present invention. It should be appreciated that FIG. 4 provides only an illustration of one implementation and does not imply any limitations with regard to the environments in which different embodiments may be implemented. Many modifications to the depicted environment may be made.

The computing system can include one or more processors 402, one or more computer-readable RAMs 404, one or more computer-readable ROMs 406, one or more computer readable storage media 408, device drivers 412, read/write drive or interface 414, and network adapter or interface 416, all interconnected over a communications fabric 418. Communications fabric 418 can be implemented with any architecture designed for passing data and/or control information between processors (such as microprocessors, communications and network processors, etc.), system memory, peripheral devices, and any other hardware components within the system.

One or more operating systems 410, and application programs 411, such as the router component 120 and request completion coordination component 130 are stored on one or more of the computer readable storage media 408 for execution by one or more of the processors 402 via one or more of the respective RAMs 404 (which typically include cache memory). In the illustrated embodiment, each of the computer readable storage media 408 can be a magnetic disk storage device of an internal hard drive, CD-ROM, DVD, memory stick, magnetic tape, magnetic disk, optical disk, a semiconductor storage device such as RAM, ROM, EPROM, flash memory, or any other computer readable storage media that can store a computer program and digital information, in accordance with embodiments of the invention.

The computing system can also include a R/W drive or interface 414 to read from and write to one or more portable computer readable storage media 426. Application programs 411 on the computing system can be stored on one or more of the portable computer readable storage media 426, read via the respective R/W drive or interface 414 and loaded into the respective computer readable storage media 408.

The computing system can also include a network adapter or interface 416, such as a TCP/IP adapter card or wireless communication adapter. Application programs 411 on the computing system can be downloaded to the computing device from an external computer or external storage device via a network (for example, the Internet, a local area network or other wide area networks or wireless networks) and network adapter or interface 416. From the network adapter or interface 416, the programs may be loaded into the computer readable storage media 408. The network may comprise copper wires, optical fibers, wireless transmission, routers, firewalls, switches, gateway computers and edge servers.

The computing system can also include a display screen 420, a keyboard or keypad 422, and a computer mouse or touchpad 424. Device drivers 412 interface to display screen 420 for imaging, to keyboard or keypad 422, to computer mouse or touchpad 424, and/or to display screen 420 for pressure sensing of alphanumeric character entry and user selections. The device drivers 412, R/W drive or interface 414, and network adapter or interface 416 can comprise hardware and software stored in computer readable storage media 408 and/or ROM 406.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

### Cloud Computing

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service’s provider.

Broad network access: capabilities are available over a network and accessed through standard mechanisms that promote use by heterogeneous thin or thick client platforms (e.g., mobile phones, laptops, and PDAs).

Resource pooling: the provider’s computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider’s applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

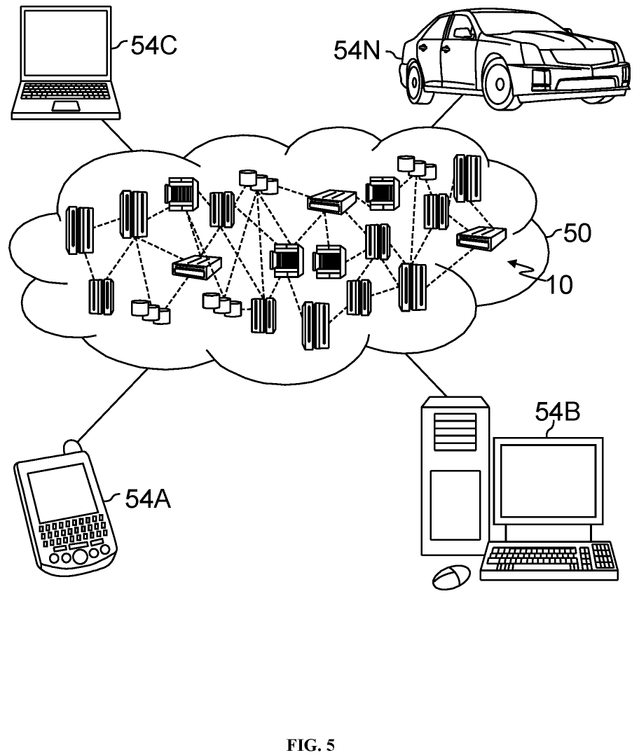

Referring now to FIG. 5, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 10 and cloud computing environment 50 can communicate with any type of computerized device over any type of network and/or network addressable connection (e.g., using a web browser).

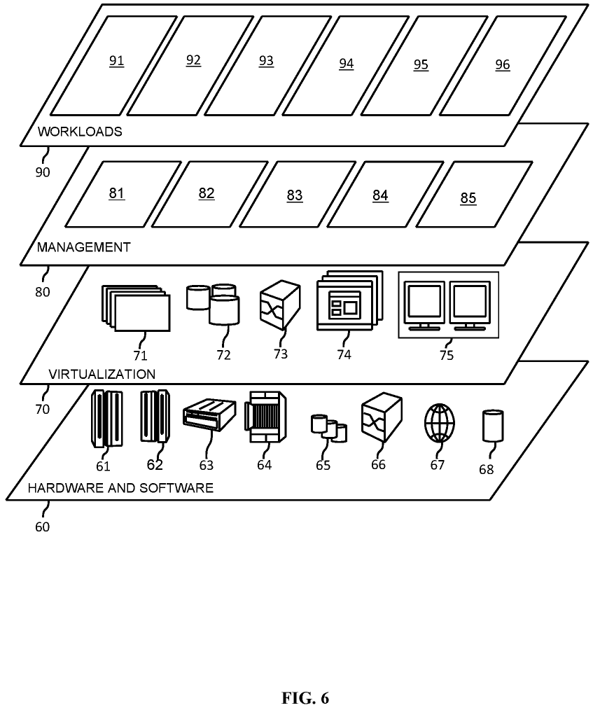

Referring now to FIG. 6, a set of functional abstraction layers provided by cloud computing environment 50 (FIG. 5) is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and request routing processing 96.

A computer program product of the present invention comprises one or more computer readable hardware storage devices having computer readable program code stored therein, said program code executable by one or more processors to implement the methods of the present invention.

A computer system of the present invention comprises one or more processors, one or more memories, and one or more computer readable hardware storage devices, said one or more hardware storage device containing program code executable by the one or more processors via the one or more memories to implement the methods of the present invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Improvements and modifications can be made to the foregoing without departing from the scope of the present invention.

What is claimed is:

1. A computer-implemented method for configuring application instances on scaling, the method comprising:
receiving a client request, wherein the client request includes one or more commands;
determining whether the client request is to be acted on by all application instances based on a type of client request, wherein the type of client request is determined based on at least routing metadata in an application interface specification; and
determining the client request is to be acted on by all application instances.

2. The method of claim 1, further comprising:
sending the client request to all current application instances.

3. The method of claim 2, further comprising:
determining whether the client request includes a cancel command by checking the command canceling metadata for the type of client request; and
canceling cached commands if the client request includes the cancel command; and
caching the one or more commands of the client request, wherein the one or more commands are cached for sending to future application instances.

4. The method of claim 3, further comprising:
maintaining a cache of commands for sending to future application instances; and
registering an application interface specification for an application including the command canceling metadata for the type of client request, indicating the cancel command to be applied to the cache of commands.

5. The method of claim 3, further comprising:
monitoring for a new application instance; and
identifying the new application instance and determining the new application instance is launched and ready to receive requests.

6. The method of claim 4, further comprising:
sending a current set of cached commands, wherein the current set of cached commands are utilized in configuring the new application instance.

7. The method of claim 2, further comprising:
sending one or more responses to the client request in accordance with response metadata for the type of client request in the application interface specification, wherein the one or more responses are sent for all the application instances, including new application instances to which commands of the client request have been sent.

8. The method of claim 7, further comprising:
aggregating the one or more responses to the client request for all the application instances into a single response.

9. The method of claim 1, wherein the one or more commands of the client request includes a stateful command to be performed on all the application instances including future application instances, wherein the stateful command maintains consistency across all the application instances.

10. The method of claim 1, wherein the method is carried out at a router component in front of a scalable application, wherein the scalable application is capable of multiple application instances located in a scalable cloud environment.

11. A computer system for configuring application instances on scaling, comprising:
one or more processors, one or more computer-readable memories, one or more computer-readable tangible storage medium, and program instructions stored on at least one of the one or more tangible storage medium for execution by at least one of the one or more processors via at least one or more memories, wherein the computer system is capable of performing a method comprising:
receiving a client request, wherein the client request includes one or more commands;
determining whether the client request is to be acted on by all application instances based on a type of client request, wherein the type of client request is determined based on at least routing metadata in an application interface specification; and
determining the client request is to be acted on by all application instances.

12. The computer system of claim 11, further comprising:
sending the client request to all current application instances.

13. The computer system of claim 12, further comprising:
determining whether the client request includes a cancel command by checking the command canceling metadata for the type of client request;
canceling cached commands if the client request includes the cancel command; and
caching the one or more commands of the client request, wherein the one or more commands are cached for sending to future application instances.

14. The computer system of claim 13, further comprising:
maintaining a cache of commands for sending to future application instances; and
registering an application interface specification for an application including the command canceling metadata for the type of client request, indicating the cancel command to be applied to the cache of commands.

15. The computer system of claim 13, further comprising:
monitoring for a new application instance; and
identifying the new application instance and determining the new application instance is launched and ready to receive requests.

16. A computer program product for configuring application instances on scaling, comprising:
one or more non-transitory computer-readable storage media and program instructions stored on at least one of the one or more tangible storage media, the program instructions executable by a processor to cause the processor to perform a method comprising:
receiving a client request, wherein the client request includes one or more commands;
determining whether the client request is to be acted on by all application instances based on a type of client request, wherein the type of client request is determined based on at least routing metadata in an application interface specification; and
determining the client request is to be acted on by all application instances.

17. The computer program product of claim 16, further comprising:
sending the client request to all current application instances.

18. The computer program product of claim 17, further comprising:
determining whether the client request includes a cancel command by checking the command canceling metadata for the type of client request;
canceling cached commands if the client request includes the cancel command; and
caching the one or more commands of the client request, wherein the one or more commands are cached for sending to future application instances.

19. The computer program product of claim 18, further comprising:
maintaining a cache of commands for sending to future application instances; and
registering an application interface specification for an application including the command canceling metadata for the type of client request, indicating the cancel command to be applied to the cache of commands.

20. The computer program product of claim 18, further comprising:
monitoring for a new application instance; and
identifying the new application instance and determining the new application instance is launched and ready to receive requests.
